(19) United States
(12) Patent Application Publication
(10) Pub. No.: US 2024/0369969 A1
(43) Pub. Date: Nov. 7, 2024

(54) HOLOGRAM IMAGE GENERATING SYSTEM AND OPERATION METHOD THEREOF

(71) Applicant: ELECTRONICS AND TELECOMMUNICATIONS RESEARCH INSTITUTE, Daejeon (KR)

(72) Inventors: Sang Hoon CHEON, Daejeon (KR); Won-Ok KWON, Daejeon (KR); Joong-Ki PARK, Daejeon (KR)

(21) Appl. No.: 18/442,922

(22) Filed: Feb. 15, 2024

(30) Foreign Application Priority Data
May 4, 2023 (KR) 10-2023-0058156

(51) Int. Cl. G03H 1/08; G06T 7/55; G06T 17/00

(52) U.S. Cl. CPC G03H 1/0808; G06T 7/55; G06T 17/00; G03H 2210/452; G06T 2207/10028; G06T 2207/20056; G06T 2210/56

(57) ABSTRACT

Disclosed is a hologram image generating system, which includes a preprocessor that receives point cloud data to convert the received point cloud data into depth map image data, a depth map hologram processor that generates depth map hologram data based on the depth map image data, and a hologram generating device that generates a hologram image based on the depth map hologram data.

### CROSS-REFERENCE TO RELATED APPLICATIONS

This application claims priority under 35 U.S.C. § 119 to Korean Patent Application No. 10-2023-0058156 filed on May 4, 2023, in the Korean Intellectual Property Office, the disclosures of which are incorporated by reference herein in their entireties.

### BACKGROUND

Embodiments of the present disclosure described herein relate to a hologram image generating system. More particularly, the present disclosure relates to a hologram image generating system that operates based on point cloud data.

3D models may be expressed in one of three formats, including depth maps, point clouds, or meshes. In particular, recently, technologies for generating hologram images in real time based on 3D models are being researched to implement media services.

However, when the hologram images based on the 3D models in the point cloud format are generated, a very large amount of computation may be required to generate the hologram images. Accordingly, it may take a long time to convert the 3D models in the point cloud format into the hologram images.

### SUMMARY

Embodiments of the present disclosure are to solve the above-mentioned technical problem. More particularly, embodiments of the present disclosure provide a hologram image generating system capable of converting a 3D model in a point cloud format into a hologram image at high speed, and a method of operating the same.

According to an embodiment of the present disclosure, a hologram image generating system includes a preprocessor that receives point cloud data to convert the received point cloud data into depth map image data, a depth map hologram processor that generates depth map hologram data based on the depth map image data, and a hologram generating device that generates a hologram image based on the depth map hologram data.

According to an embodiment of the present disclosure, a method of operating a hologram image generating system includes receiving point cloud data, converting the point cloud data into depth map image data, generating depth map hologram data based on the depth map image data, and generating a hologram image based on the depth map hologram data.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a hologram image generating system, according to an embodiment of the present disclosure.

FIG. 2 is a diagram illustrating point cloud data PCD of FIG. 1.

FIG. 3 is a diagram illustrating a light wave for one of point light sources illustrated in FIG. 2.

FIG. 4 is a diagram illustrating depth map image data of FIG. 1.

FIG. 5 is a diagram illustrating a preprocessor of FIG. 1.

FIGS. 6A to 6C are diagrams illustrating an operation of a preprocessor of FIG. 1 in more detail.

FIGS. 7A to 7C are diagrams illustrating point cloud data, depth map image data, and hologram images according to an embodiment of the present disclosure.

FIG. 8 is a flowchart illustrating a method of operating a hologram image generating system of FIG. 1.

FIG. 9 is a flowchart illustrating operation S120 of FIG. 8 in more detail.

### DETAILED DESCRIPTION

Hereinafter, embodiments of the present disclosure will be described in detail and clearly to such an extent that an ordinary one in the art easily implements the present disclosure. Specific details such as detailed components and structures are merely provided to assist the overall understanding of the embodiments of the present disclosure. Therefore, it should be apparent to those skilled in the art that various changes and modifications of the embodiments described herein may be made without departing from the scope and spirit of the present disclosure. Moreover, descriptions of well-known functions and structures will be omitted for clarity and conciseness. In the following drawings or in the detailed description, components may be connected with any other components except for components illustrated in a drawing or described in the detailed description. The terms used in the specification are terms defined in consideration of the functions in the present disclosure and are not limited to a specific function. The definitions of the terms should be determined based on the contents throughout the specification.

Components that are described in the detailed description with reference to the terms “driver”, or block”, etc. will be implemented with software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, an inertial sensor, a microelectromechanical system (MEMS), a passive element, or a combination thereof.

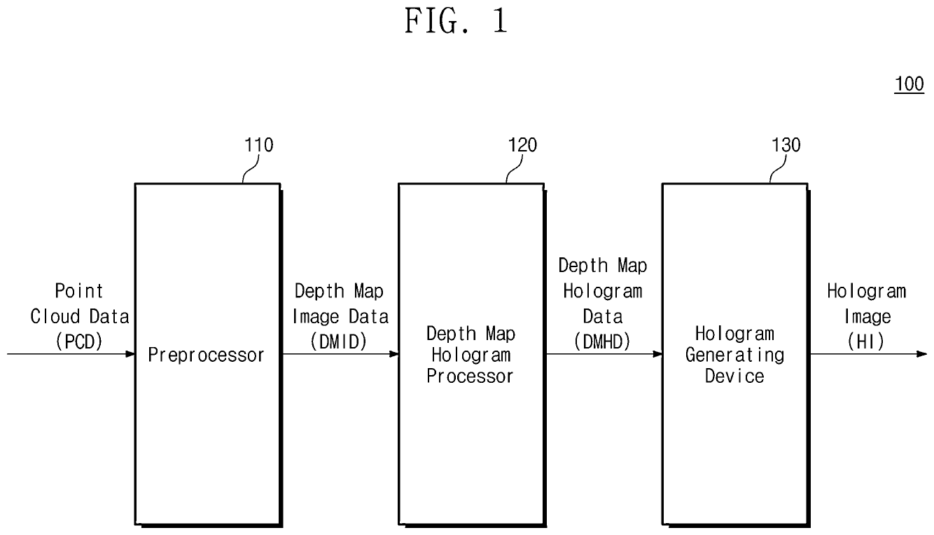

FIG. 1 is a diagram illustrating a hologram image generating system, according to an embodiment of the present disclosure. Referring to FIG. 1, a hologram image generating system 100 may include a preprocessor 110, a depth map hologram processor 120, and a hologram generating device 130.

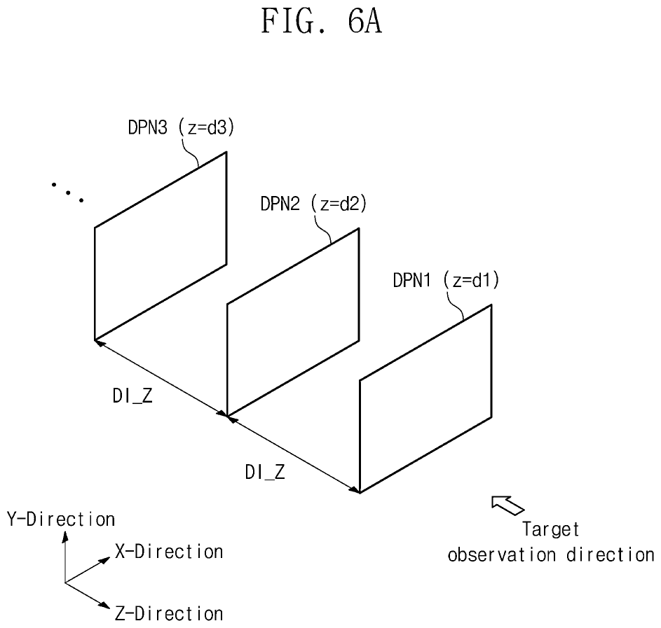

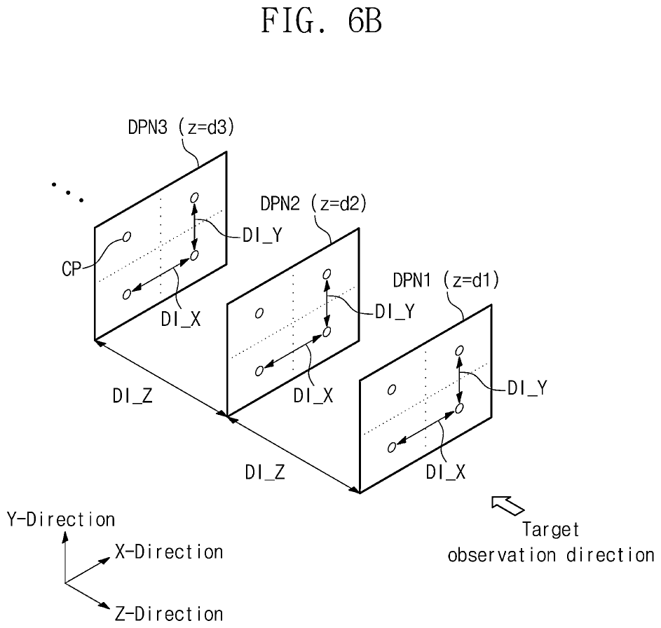

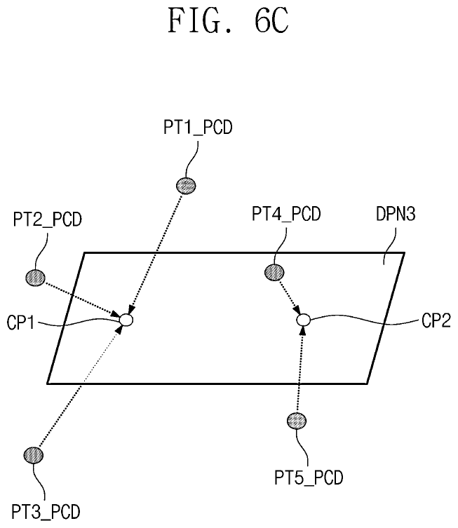

The preprocessor 110 may receive point cloud data PCD. The preprocessor 110 may convert the point cloud data PCD into depth map image data DMID. For example, the preprocessor 110 may convert the point cloud data PCD into a depth map format to prevent distortion in a hologram image in a target observation direction. A more detailed operation of the preprocessor 110 will be described in detail with reference to FIGS. 5 and 6A to 6C below.

In an embodiment, point cloud data PCD may be 3D model data.

In an embodiment, the preprocessor 110 may receive the point cloud data PCD through an Ethernet. However, the scope of the present disclosure is not limited thereto, and the preprocessor 110 may receive the point cloud data PCD through an HDMI (High Definition Multimedia Interface). In detail, the scope of the present disclosure is not limited to the specific manner in which the preprocessor 110 receives data.

In an embodiment, the depth map image data DMID may include a plurality of depth images corresponding to different depths.

The depth map hologram processor 120 may receive the depth map image data DMID. The depth map hologram processor 120 may generate depth map hologram data DMHD based on the depth map image data DMID. For example, the depth map hologram processor 120 may perform a Fast Fourier Transform (FFT) calculation on a plurality of depth images included in the depth map image data DMID to generate the depth map hologram data DMHD.

The hologram generating device 130 may generate a hologram image HI based on the depth map hologram data DMHD.

In an embodiment, the hologram generating device 130 may be implemented with a spatial light modulator (SLM). However, the scope of the present disclosure is not limited thereto.

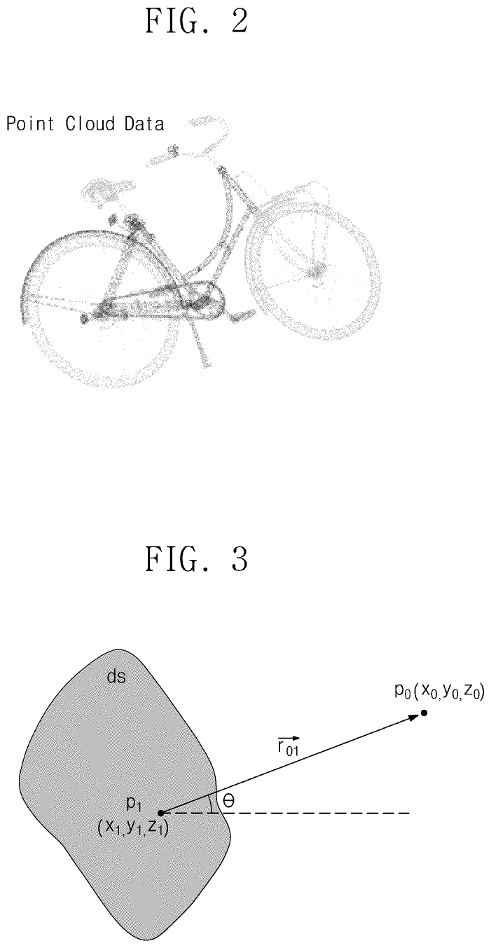

FIG. 2 is a diagram illustrating point cloud data PCD of FIG. 1. Referring to FIG. 2, the point cloud data PCD may be implemented as a 3D model containing a very large number of point light sources.

In the case of the conventional art, a hologram image is generated by calculating light waves for each point light source of the point cloud data PCD and providing the calculated results to a hologram generating device. Accordingly, since light wave calculations are required for each of a very large number of point light sources, a very large amount of computation is required. The method of calculating light waves for one point light source will be described in detail with reference to FIG. 3 below.

FIG. 3 is a diagram illustrating a light wave for one of point light sources illustrated in FIG. 2. Referring to FIGS. 2 and 3, a micro area ds in FIG. 3 may correspond to one of the point light sources in FIG. 2.

The distribution of light wave propagation over the micro area ds of a P₁ coordinate (i.e., x₁, y₁, and z₁) may be calculated through a “Rayleigh-Sommerfeld propagation” equation. In detail, a distribution U (P₀) of the light wave propagation at a point P₀ over the micro area ds may be calculated through Equation 1 below.

$$U ( {P}_{0} ) = - \frac{1}{2 π} \int \int U ( {P}_{1} ) ( jk - \frac{1}{{r}_{01}} ) \frac{exp ( {jkr}_{01} )}{{r}_{01}} cos θ ds . \qquad [ Equation 1 ]$$

In this case, r₀₁ will be calculated based on Equation 2 below.

$${r}_{01} = \sqrt{{( {x}_{1} - {x}_{0} )}^{2} + {( {y}_{1} - {y}_{0} )}^{2} + {( {z}_{1} - {z}_{0} )}^{2}} . \qquad [ Equation 2 ]$$

In an embodiment, a conventional method of generating a hologram image based on point cloud data may be performed by calculating and summing the distribution of light wave propagation for each point light source based on Equation 1. In this case, very large computing resources may be required to generate a hologram image from the point cloud data.

In contrast with this, according to an embodiment of the present disclosure, the calculation for Equation 1 described above may be performed concisely under specific conditions. For example, when a function as in Equation 3 below is defined, the above-described Equation 1 may be expressed more concisely as Equation 4 below.

$$h ( x , y ; z ) = \frac{1}{2 π} \frac{z}{r} ( \frac{1}{r} - jk ) \frac{exp ( jkr )}{r} \qquad [ Equation 3 ]$$

$$U ( {P}_{0} ) = \int \int U ( {P}_{1} ) h ( {P}_{0} , {P}_{1} ) ds \qquad [ Equation 4 ]$$

$$U ( {x}_{0} , {y}_{0} , {z}_{0} ) = \int \int U ( {x}_{1} , {y}_{1} , {z}_{1} ) h ( {x}_{0} - {x}_{1} , {y}_{0} - {y}_{1} , {z}_{0} - {z}_{1} ) {dx}_{1} {dy}_{1}$$

In particular, when the ‘z’ value is uniform, Equation 4 may be more concisely converted to Equation 5 below.

$$U ( {x}_{0} , {y}_{0} , {z}_{0} ) = U ( x , y ; z ) * h ( x , y ; z ) \qquad [ Equation 5 ]$$

In this case, the convolution equation in Equation 5 may be converted as in Equation 6 below.

$$U ( {x}_{0} , {y}_{0} , {z}_{0} ) = {- 1}^{} [ Ψ \times H ] \qquad [ Equation 6 ]$$

In this case, ψ may represent the Fourier transform of the P₁ field distribution. For example, ψ may be expressed as Equation 7 below.

$$Ψ = [ U ] \qquad [ Equation 7 ]$$

Meanwhile, H may be defined as Equation 8 below.

$$H = [ h ( x , y ; z ) ] = exp ( {jk}_{0} z \sqrt{1 - {k}_{z}^{2} / {k}_{0}^{2} - {k}_{z}^{2} / {k}_{0}^{2}} ) \qquad [ Equation 8 ]$$

In this case, Equation 8 may represent an angular spectrum. Meanwhile, since it may be defined as k₀²=kₓ²+k_{y}²+k_{z}², the above-described equation 8 may be expressed as Equation 9 below.

$$H = exp ( - {jk}_{z} z ) \qquad [ Equation 9 ]$$

Therefore, through Equation 7 and Equation 9 described above, Equation 6 described above may be concisely expressed as Equation 10 below.

$$U ( {x}_{0} , {y}_{0} , {z}_{0} ) = {- 1}^{} [ Ψ \times exp ( - {jk}_{z} z ) ] \qquad [ Equation 10 ]$$

In detail, when the above-described ‘z’ value is uniform and the conditions for quickly performing the above-described Fourier transform are met, the value of Equation 1 described above may be quickly calculated through Equation 10 described above.

That is, according to an embodiment of the present disclosure, when point light source points are in one plane (i.e., when the ‘z’ value is uniform and Equation 4 may be expressed as Equation 5), and are arranged at equal intervals in an ‘x’ direction and a ‘y’ direction (i.e., when the conditions for quickly calculating Equation 7 described above are met), light waves for each point light source may be calculated more quickly. The conversion of the point cloud data PCD into the hologram image HI according to these conditions will be described in detail with reference to the drawings below.

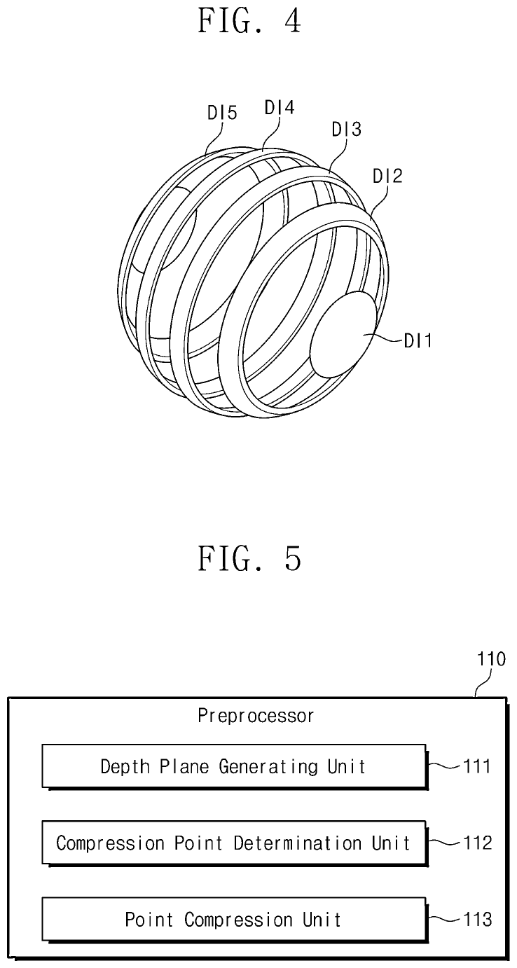

FIG. 4 is a diagram illustrating depth map image data of FIG. 1. Referring to FIG. 4, a 3D model may be expressed as the sum of a plurality of planes. In detail, the 3D model may be expressed as a plurality of depth images divided according to a plurality of depth planes perpendicular to the observation direction. For example, the 3D model may be expressed as five depth images DI1 to DI5. In this case, depth map hologram data for each depth image may be calculated through an FFT (Fast Fourier Transform). Therefore, according to an embodiment of the present disclosure, it will be possible to generate the hologram image HI at high speed, compared to generating a hologram image based on the point cloud data PCD (i.e., generating a hologram image by calculating Equation 1 described above without using the FFT). A specific method in which the preprocessor 110 generates the depth map image data DMID will be described in more detail with reference to the drawings below.

FIG. 5 is a diagram illustrating a preprocessor of FIG. 1. Referring to FIGS. 1 and 5, the preprocessor 110 may include a depth plane generating unit 111, a compression point determination unit 112, and a point compression unit 113.

The depth plane generator 111 may generate a plurality of depth planes (hereinafter referred to as a ‘DPN’). In this case, the plurality of depth planes may be arranged at equal intervals from each other.

In an embodiment, each of the plurality of depth planes may be perpendicular to the target observation direction.

The compression point determination unit 112 may determine a plurality of compression points (hereinafter referred to as a ‘CP’) with respect to each depth plane. For example, the compression point determination unit 112 may determine a first plurality of compression points with respect to a first depth plane, and in this case, each of the first plurality of compression points may be arranged in a matrix form on the first depth plane. As in the above description, the compression point determination unit 112 may determine a second plurality of compression points with respect to a second depth plane. In this case, each of the second plurality of compression points may be arranged in a matrix form on the second depth plane. The arrangement of compression points will be described in more detail with reference to FIGS. 6A to 6C below.

The point compression unit 113 may compress points of the point cloud data PCD into compression points. For example, the point compression unit 113 may compress each point of the point cloud data PCD into the closest compression point. A method in which points of the point cloud data PCD are compressed into the compression point will be described in more detail with reference to FIG. 6C below.

FIGS. 6A to 6C are diagrams illustrating an operation of a preprocessor of FIG. 1 in more detail. First, referring to FIGS. 1, 5, and 6A, the depth plane generating unit 111 may generate a plurality of depth planes. Hereinafter, for a more concise description, first to third depth planes DPN1 to DPN3 among the plurality of depth planes will be representatively described. However, the scope of the present disclosure is not limited to the number of depth planes generated by the depth plane generating unit 111.

In an embodiment, the plurality of depth planes may be perpendicular to the target observation direction. For example, each of the first to third depth planes DPN1 to DPN3 may be a plane perpendicular to the target observation direction. In this case, the first to third depth planes DPN1 to DPN3 will be parallel to each other. Hereinafter, for more concise description, the target observation direction will be assumed to be parallel to the Z-direction.

In an embodiment, the plurality of depth planes may be arranged at equal intervals from each other. For example, the intervals between the first to third depth planes DPN1 to DPN3 may be uniform with the first interval DI_Z. However, the scope of the present disclosure is not limited thereto.

Next, referring to FIGS. 1, 5, and 6A to 6B, the compression point determination unit 112 may determine a plurality of compression points for each depth plane. Hereinafter, the compression points CP on the third depth plane DPN3 will be representatively described.

The compression points CP may be arranged at equal intervals from each other. For example, the interval in an X-direction between the compression points CP may be uniform with a second interval DI_X, and the interval in a Y-direction between the compression points CP may be uniform with a third interval DI_Y. In detail, the compression points CP may be arranged in a matrix structure on the depth plane DPN. However, the scope of the present disclosure is not limited thereto.

Next, referring to FIGS. 1, 5, and 6A to 6C, the point compression unit 113 may compress points of the point cloud data PCD into compression points. Hereinafter, a compression operation for first to fifth points PT1_PCD to PT5_PCD among the points of the point cloud data PCD will be representatively described. In addition, hereinafter, an embodiment in which each of the first to fifth points PT1_PCD to PT5_PCD is closest to the third depth plane DPN3 among the plurality of depth planes will be representatively described.

The first to third points PT1_PCD to PT3_PCD may be closest to a first compression point CP1 among the plurality of compression points CP. In this case, the first to third points PT1_PCD to PT3_PCD may be compressed into the first compression point CP1.

In contrast, the fourth to fifth points PT4_PCD to PT5_PCD may be closest to a second compression point CP2 among the plurality of compression points CP. In this case, the fourth to fifth points PT4_PCD to PT5_PCD may be compressed into the second compression point CP2.

In this case, the first compression point CP1 and the second compression point CP2 may be included in the depth image with respect to the third depth plane PN3. In detail, the depth image with respect to the third depth plane PN3 may be composed of a plurality of compression points. As in the above description, each of the plurality of depth planes may configure a different depth image.

In an embodiment, compression points of each of the plurality of depth images may be arranged on the same plane and at equal intervals in the X-direction and Y-direction. In this case, the light wave for each of the compression points may be quickly calculated using Equation 10 described above. Therefore, according to an embodiment of the present disclosure, generation of the hologram image HI based on the point cloud data PCD may be performed at high speed.

In an embodiment, when an observer's viewing angle of the hologram image HI is limited to the target observation direction, distortion of the generated hologram image HI may not be observed even if the points of the point cloud data PCD are compressed into compression points. In particular, when the resolution of the compression points in the X-direction and Y-direction is sufficiently large (i.e., when the sizes of the second interval DI_X and the third interval DI_Y are sufficiently small), the distortion of the generated hologram image HI may not be observed.

In an embodiment, according to an embodiment of the present disclosure, the hologram image HI may change in real time in response to the point cloud data PCD. In detail, according to an embodiment of the present disclosure, the hologram image generating system 100 that generates the hologram image HI in real time may be provided.

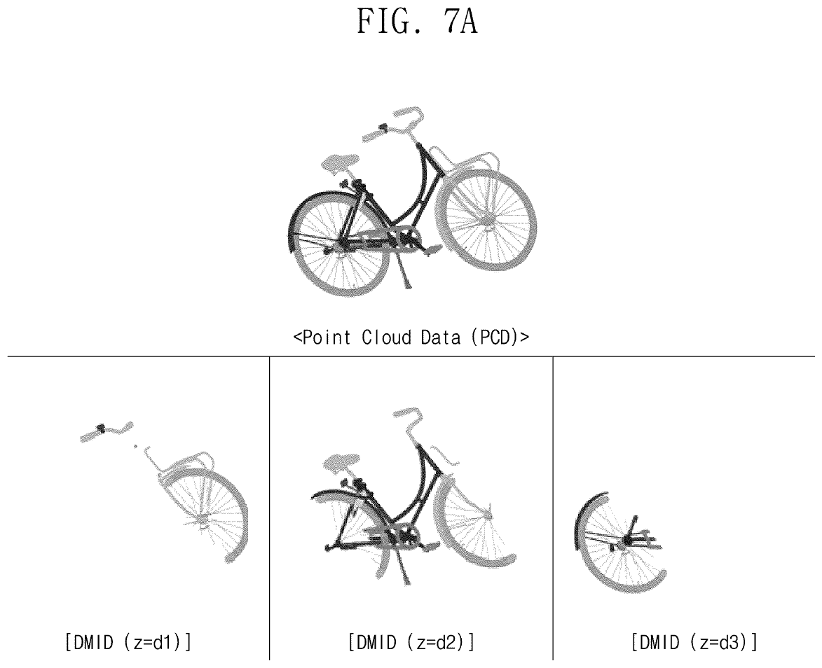

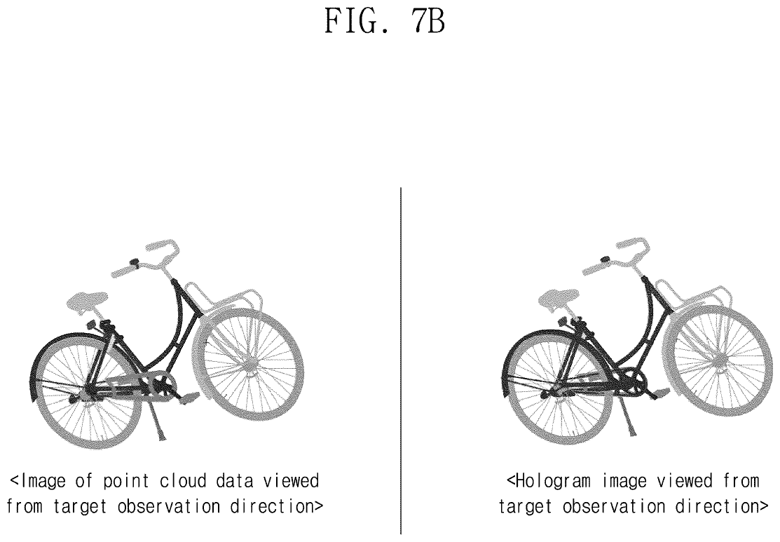

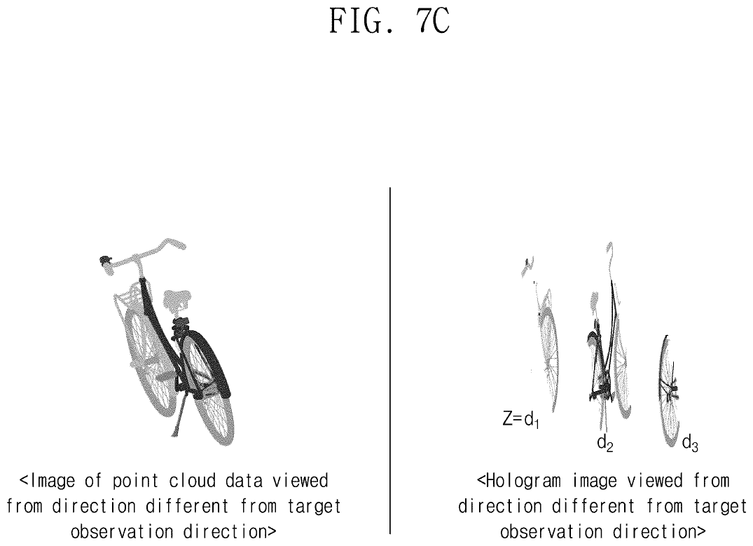

FIGS. 7A to 7C are diagrams illustrating point cloud data, depth map image data, and hologram images according to an embodiment of the present disclosure. Hereinafter, an embodiment in which the point cloud data PCD is compressed into compression points of three depth planes DPN will be described by way of example. However, the scope of the present disclosure is not limited thereto.

First, referring to FIG. 7A, the depth map image data DMID according to an embodiment of the present disclosure may include compression points in a (z=d1) plane, a (z=d2) plane, and a (z=d3) plane. In detail, the point cloud data PCD may be divided into three depth images depending on the distance from the target observation direction.

Next, referring to FIG. 7B, when the hologram image HI generated according to an embodiment of the present disclosure is viewed from the target observation direction, the shape of the 3D model represented by the point cloud data PCD may be observed without distortion.

In contrast, referring to FIG. 7C, when the hologram image HI generated according to an embodiment of the present disclosure is viewed from a direction different from the target observation direction, the 3D model represented by the point cloud data PCD may be observed in a distorted shape. In detail, when the hologram image HI is viewed from a direction different from the target observation direction, the above-described first to third depth planes DPN1 to DPN3 may be observed individually. For example, the (z=d1) plane, (z=d2) plane, and (z=d3) plane may be observed individually.

In detail, when the hologram image HI generated according to an embodiment of the present disclosure is viewed from a direction different from the target observation direction, the 3D model represented by the point cloud data PCD will be observed in a distorted shape.

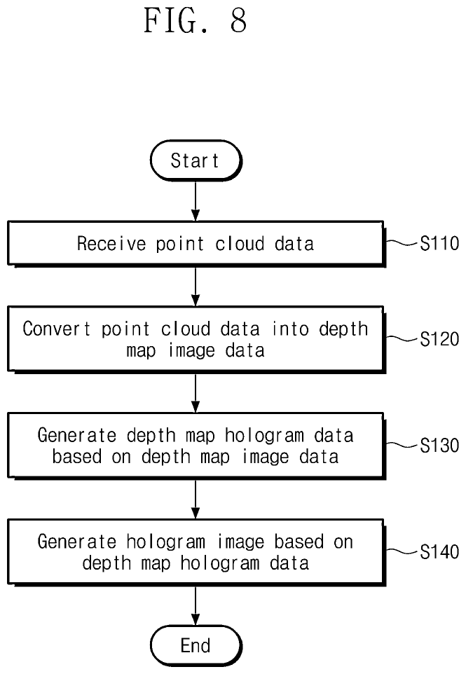

FIG. 8 is a flowchart illustrating a method of operating a hologram image generating system of FIG. 1. Referring to FIGS. 1 to 8, in operation S110, the hologram image generating system 100 may receive the point cloud data PCD. For example, the preprocessor 110 may receive the point cloud data PCD through the Ethernet.

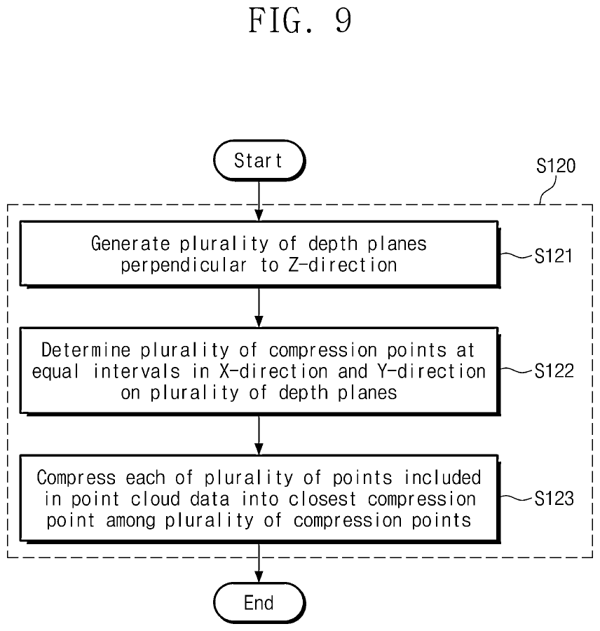

In operation S120, the hologram image generating system 100 may convert the point cloud data PCD into the depth map image data DMID. For example, the preprocessor 110 may convert the point cloud data PCD into the depth map image data DMID. The method by which the preprocessor 110 converts the point cloud data PCD into the depth map image data DMID will be described in more detail with reference to FIG. 9 below.

In operation S130, the hologram image generating system 100 may generate the depth map hologram data DMHD based on the depth map image data DMID. For example, the depth map hologram processor 120 may generate the depth map hologram data DMHD by performing the calculation of Equation 10 described above.

In operation S140, the hologram image generating system 100 may generate the hologram image HI based on the depth map hologram data DMHD. For example, the hologram generating unit 130 may display the hologram image HI based on the depth map hologram data DMHD.

In an embodiment, operations S110 to S140 may be performed at a very high speed. Accordingly, the hologram image HI may reflect the point cloud data PCD received to the hologram image generating system 100 in real time.

FIG. 9 is a flowchart illustrating operation S120 of FIG. 8 in more detail. Referring to FIGS. 1 to 9, operation S120 may include operations S121 to S123.

In operation S121, the preprocessor 110 may generate the plurality of depth planes DPN perpendicular to the Z-direction. In this case, the plurality of depth planes may be perpendicular to the target observation direction and may be spaced apart from each other by the same interval.

In operation S121, the preprocessor 110 may generate the plurality of depth planes DPN perpendicular to the Z-direction. For example, the depth plane generating unit 111 may generate the plurality of depth planes. In this case, the plurality of depth planes may be perpendicular to the target observation direction and may be spaced apart from each other by the same interval.

In operation S122, the preprocessor 110 may determine a plurality of compression points at equal intervals in the X-direction and Y-direction on the plurality of depth planes. For example, the compression point determination unit 112 may determine a plurality of compression points for each depth plane.

In operation S123, the preprocessor 110 may compress each of the plurality of points included in the point cloud data PCD into the closest compression point among the plurality of compression points. For example, the point compression unit 113 may compress points of the point cloud data PCD into the closest compression point.

In an embodiment, each of the compression points may be arranged on the same plane and may be arranged at equal intervals from each other in the X-direction and Y-direction. In this case, the light wave for each of the compression points may be quickly calculated using Equation 10 described above. Therefore, according to an embodiment of the present disclosure, generation of the hologram image HI based on the point cloud data PCD may be performed at high speed.

According to an embodiment of the present disclosure, a 3D model in a point cloud format may be converted into a hologram image at high speed. In this case, a hologram image generating system and a method of operating the same that convert the 3D model in the point cloud format into the hologram image in real time may be provided.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to exemplary embodiments thereof, it will be apparent to those of ordinary skill in the art that various changes and modifications may be made thereto without departing from the spirit and scope of the present disclosure as set forth in the following claims.

What is claimed is:

1. A hologram image generating system comprising:
a preprocessor configured to receive point cloud data to convert the received point cloud data into depth map image data;
a depth map hologram processor configured to generate depth map hologram data based on the depth map image data; and
a hologram generating device configured to generate a hologram image based on the depth map hologram data.

2. The hologram image generating system of claim 1, wherein the preprocessor includes:
a depth plane generating unit configured to generate a plurality of depth planes perpendicular to a first direction;
a compression point determination unit configured to determine a plurality of compression points on the plurality of depth planes; and
a point compression unit configured to compress each of the plurality of points included in the point cloud data into a closest compression point among the plurality of compression points.

3. The hologram image generating system of claim 2, wherein a number of the plurality of compression points is less than a number of the plurality of points included in the point cloud data.

4. The hologram image generating system of claim 2, wherein an interval in a second direction between the plurality of compression points is a first interval, and
an interval in a third direction between the plurality of compression points is a second interval.

5. The hologram image generating system of claim 4, wherein the first direction is an observation direction of the hologram image, and
the second direction and the third direction are perpendicular to the first direction.

6. The hologram image generating system of claim 2, wherein each of the plurality of depth planes is parallel to each other.

7. The hologram image generating system of claim 6, wherein an interval between the plurality of depth planes is a third interval.

8. The hologram image generating system of claim 2, wherein the depth map image data includes a plurality of depth images corresponding to different depths, and
the plurality of depth planes each correspond to the plurality of depth images.

9. The hologram image generating system of claim 1, wherein the depth map hologram processor is configured to generate the depth map hologram data through an FFT.

10. The hologram image generating system of claim 1, wherein the hologram generating device is an SLM which operates in a depth map method.

11. The hologram image generating system of claim 1, wherein the hologram image changes in real time in response to the point cloud data.

12. The hologram image generating system of claim 1, wherein the preprocessor receives the point cloud data through an Ethernet, and
the hologram generating device is configured to receive the depth map hologram data through an HDMI (High Definition Multimedia Interface).

13. A method of operating a hologram image generating system, the method comprising:
receiving point cloud data;
converting the point cloud data into depth map image data;
generating depth map hologram data based on the depth map image data; and
generating a hologram image based on the depth map hologram data.

14. The method of claim 13, wherein the converting of the point cloud data includes:
generating a plurality of depth planes perpendicular to a first direction;
determining a plurality of compression points, which is equal interval in a second direction and a third direction, on the plurality of depth planes; and
compressing each of the plurality of points included in the point cloud data into a closest compression point among the plurality of compression points.

15. The method of claim 14, wherein the first direction is an observation direction of the hologram image, and
the second direction and the third direction are perpendicular to the first direction.

16. The method of claim 15, wherein each of the plurality of depth planes is parallel to each other.

17. The method of claim 16, wherein the number of the plurality of compression points is less than the number of the plurality of points included in the point cloud data.
